(19) United States
(12) Patent Application Publication
(10) Pub. No.: US 2002/0051620 A1
(43) Pub. Date: May 2, 2002

(54) Method of playback of image in a digital TV transmission/reception system

(76) Inventor: Muneomi Katayama, Tokyo (JP)

Correspondence Address: REED SMITH HAZEL & THOMAS LLP, Suite 1400, 3110 Fairview Park Drive, Falls Church, VA, 22042, US

(21) Appl. No.: 09/775,589

(22) Filed: Feb. 5, 2001

(30) Foreign Application Priority Data
Nov. 1, 2000 (JP) 2000-372122

(51) Int. Cl. H04N 5/76

(52) U.S. Cl. 386/46; 386/83

(57) ABSTRACT

A method of playback of image in a digital TV transmission/reception system is characterized by providing in a network circuit a buffer system, which has a function of, while continuing the actual real-time broadcast, recording and erasing said broadcast image and sound linked to the image in sequence and in units of second or minute and, by operation of the buffer system, enabling to reproduce the previously broadcast image and/or sound.

### BACKGROUND OF THE INVENTION

The present invention relates to a digital transmission system including contents, which use database, and more specifically relates to a playback method of broadcast image in a digital TV transmission/reception system including contents using database in a relayed TV broadcast.

In ordinary TV broadcast, for example, in a relayed broadcast of a sport, at the spot of relaying, image and sound signal from a relaying vehicle is transmitted to a TV station by use of microwave. Thereafter, it is transmitted to viewers after adding (superimposing) necessary data thereto in the master room of the station. In such a case, the image and data is displayed on the screen without regard.1to the like or dislike of the viewers, so that the viewers generally have no way of choosing to view or not the image and/or data.

### BRIEF SUMMARY OF THE INVENTION

It is therefore an object of the present invention to propose an image playback method in a novel digital TV transmission/reception system, which is capable of reproducing and transmitting a previously broadcast image and/or sound on a same channel, having images thereof separated from data linked to the images.

Another object of the present invention is to enable a viewer to display real-time those images and data simultaneous with the TV picture on a same display, without being overlapped with each other.

A first aspect of the image playback method in a digital TV transmission/reception system of the present invention is to provide a buffer system in a network circuit, which has a function of, while continuing the actual real-time broadcast, recording and erasing in sequence the broadcast image and sound linked to the image, in units of second or minute. As a result, previously broadcast image and/or sound can be reproduced by operation of the buffer system.

Specifically, in a real-time broadcast of baseball or soccer game, it is frequently probable that one fails to watch the forms or expressions of players at the moment of such as homerun hit, a soccer shoot, or at goal of horse racing with very small margin. Therefore, it is intended to enable to capture such exiting scenes as described above and display them as they are, or display the images on two or more screens, without superimposing on the real-time broadcast images.

A second aspect of the present invention is characterized in that, the system enables to reproduce the image and/or sound on a screen of an image which are being broadcast currently, by forming two screens consisting of the image and the previously broadcast image.

It means that, it is possible to enjoy images, which have been broadcast in the past, while simultaneously watching the real-time broadcast currently displayed on a same display unit.

The present invention is a digital transmission system which separately transmits image and data linked to the image through a same channel. It is so arranged that at least the digitized image and data linked to the image be separately transmitted through the same channel, such that to display the desired image and data linked to the image in response to a request from the reception side.

In this regard, the system comprises: a buffer system for temporarily storing digitized past data (contents) of currently broadcast information, which was received several second or several minutes ago; a multiplexer/modulator for transmission via surface or satellite wave; a de-multiplexer/demodulator for performing de-multiplexing/demodulation of the data signal transmitted through an ordinary TV channel using the surface or satellite waves from the multiplexer/modulator; and a receiver connected to the buffer system which receives the output from the de-multiplexer/demodulator.

### BRIEF DESCRIPTION OF THE SEVERAL VIEWS OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram illustrating the constitution of the present invention.

FIG. 2 is a block diagram illustrating the function of the present invention.

### DETAILED DESCRIPTION OF THE INVENTION

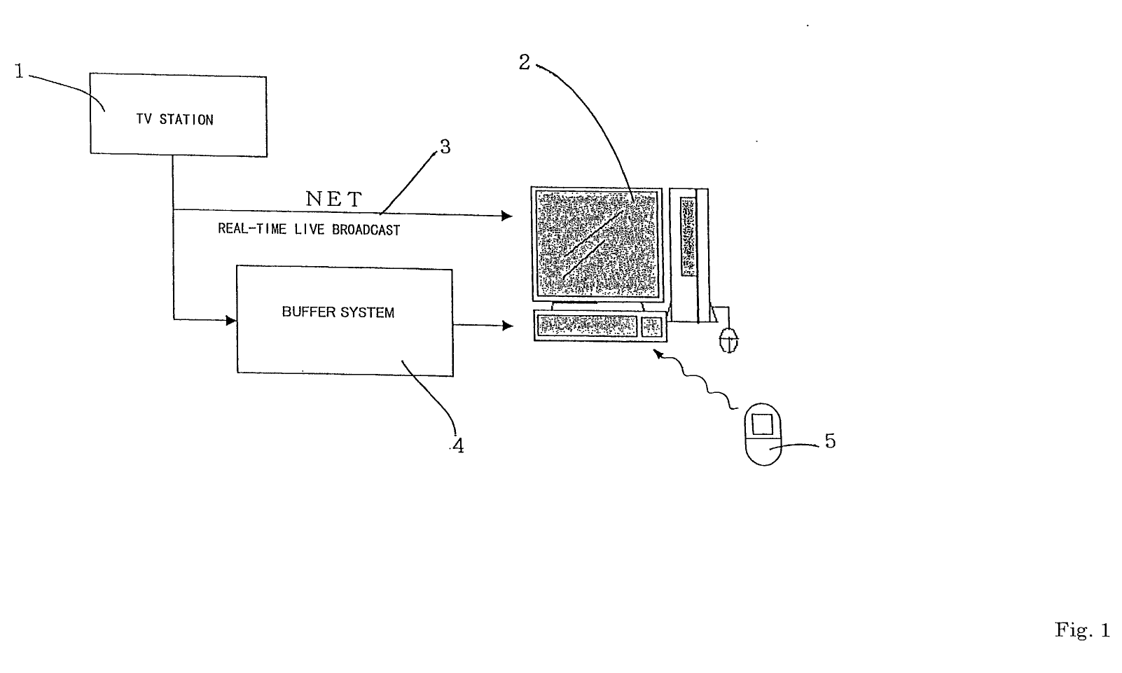

A first embodiment of the present invention will be described with reference to FIG. 1. In FIG. 1, reference numeral (1) denotes a TV station while (2) being a PC of a viewer, and real-time live broadcast is put on the air through a network system (3) Reference numeral (4) denotes a backup system, which is capable of storing the image and sound signals from the above TV station for a given period of time (in units of second or minutes). It is so arranged that a PC operator (viewer) can take out the data at will using a remote control (5) or the like.

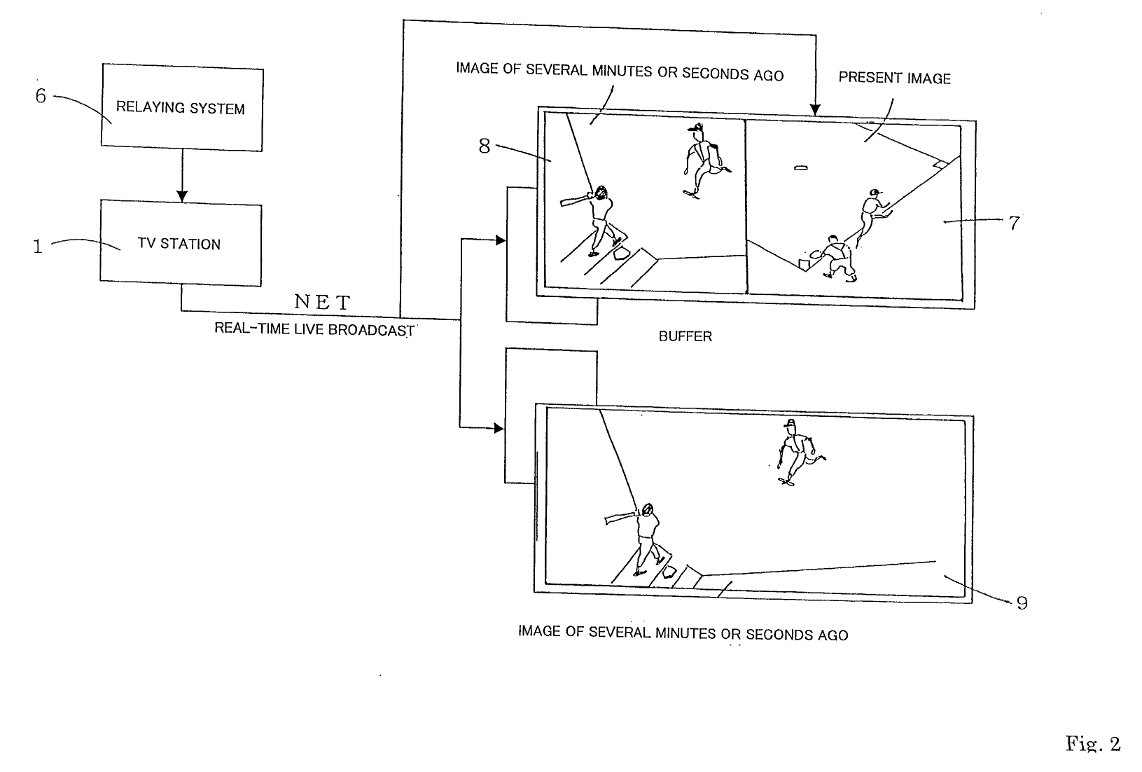

A second embodiment of the present invention will be described with reference to FIG. 2. Here, a case of reception of relay broadcast of a baseball game program by a PC is taken as an example for description. As shown in FIG. 2, a relaying system (6) gathers and transmits image and sound to the PC (2) of a viewer so as to broadcast ordinarily in a conventional manner.

Assume that, during a short period of time in which the viewer was absent, a batter hits a homerun. Then, the viewer by no means can review the image and sound of the scene, since the currently displayed image is the one appearing several seconds or minutes after the image of the hit of homerun.

As a matter of course, the viewer wants to reproduce the form and reaction of the player when hitting the homerun and cheering of the fans.

Therefore, the viewer calls the buffer system (4) to startup. As described previously, image and sound which was broadcast several seconds or minutes ago is stored in the buffer system, and the PC (2) of the viewer can display the image of several minutes or seconds ago in a form of a still image or dynamic image (9). Hence, it is made possible to reproduce in a truly real-time state the form and reaction of the player and the commotion among the audience at the moment of hit of the homerun.

Note that there is no fear of failing to watch the current broadcast while watching the reproduced image, if the image of several seconds or minutes ago is displayed side by side along with the currently broadcast image, without being overlapped with each other on the display of the same PC (2) as shown by numerals (7) and (8) in FIG. 2.

According to the present invention, a buffer system was provided in the digital image and sound currently broadcast and the real-time live broadcast, such that to display the image and sound which was broadcast several seconds or minutes prior to the current broadcast. Thereby, it was made possible to watch and enjoy the image and sound of several minutes ago, which the viewer failed to watch, as well as the real-time broadcast.

What is claimed is:

1. A method of playback of image in a digital TV transmission/reception system characterized by providing in a circuit network a buffer system, which has a function of, while continuing the actual real-time broadcast, recording and erasing in sequence said broadcast image and sound linked to the image in units of second or minute and, by operation of said buffer system, enabling to reproduce the already broadcast image and/or sound.

2. A method of playback of image in a digital TV transmission/reception system characterized by providing in a circuit network a buffer system, which has a function of, while continuing the actual real-time broadcast, recording and erasing in sequence said broadcast image and sound linked to the image in units of second or minute and, by operation of said buffer system, enables to reproduce the previously broadcast image and/or sound on the currently broadcast images, by forming two screens consisting of said image and an image which has been previously broadcast.
